(19) United States
(12) Patent Application Publication
(10) Pub. No.: US 2010/0288707 A1
(43) Pub. Date: Nov. 18, 2010

(54) METHOD FOR CONDITIONING A WASTE SOLUTION CONTAINING ORGANIC SUBSTANCES AND METALS IN IONIC FORM, OBTAINED DURING WET-CHEMICAL CLEANING OF CONVENTIONAL OR NUCLEAR PLANTS

(75) Inventors: CHRISTIAN TOPF, FORCHHEIM (DE); SILVIA SCHUSS, FELDKIRCHEN (DE); FRANZ AMMANN, ERLANGEN (DE)

Correspondence Address: LERNER GREENBERG STEMER LLP, P O BOX 2480, HOLLYWOOD, FL, 33022-2480, US

(73) Assignee: AREVA NP GMBH, ERLANGEN (DE)

(21) Appl. No.: 12/844,459

(22) Filed: Jul. 27, 2010

Related U.S. Application Data
(63) Continuation of application No. PCT/EP2009/058407, filed on Jul. 3, 2009.

(30) Foreign Application Priority Data
Jul. 7, 2008 (DE) 10 2008 040 224.9
Sep. 24, 2008 (DE) 10 2008 048 691.4

(51) Int. Cl. C02F 1/52

(52) U.S. Cl. 210/719

(57) ABSTRACT

A method is provided for conditioning a waste solution obtained during the wet-chemical cleaning of conventional or nuclear plants and containing organic substances and metals in ionic form. At least a portion of the organic substance is degraded by electrochemical treatment or UV radiation of the waste solution, at least one metal precipitates by the addition of phosphoric acid and a resultant phosphate precipitate is removed from the waste solution.

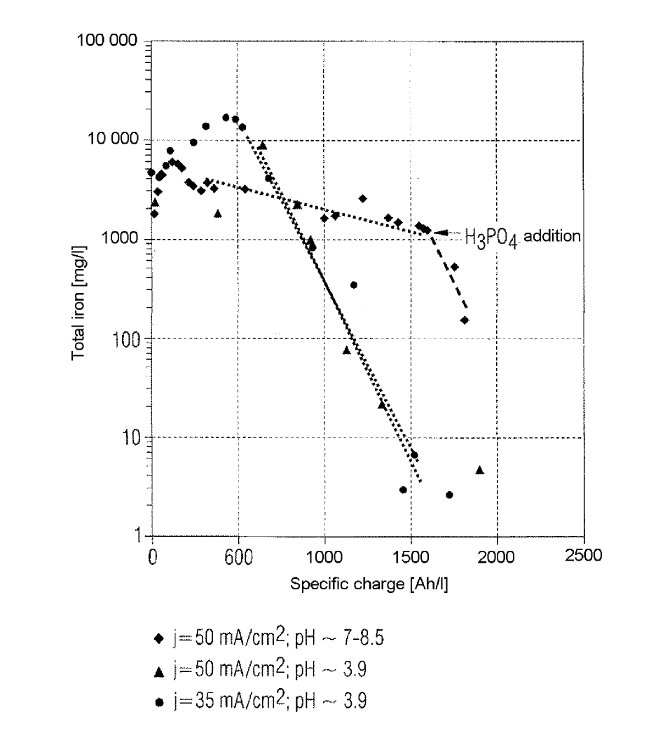

### CROSS-REFERENCE TO RELATED APPLICATION

This is a continuation application, under 35 U.S.C.§120, of copending International Application No. PCT/EP2009/058407, filed Jul. 3, 2009, which designated the United States; this application also claims the priority, under 35 U.S.C.§119, of German Patent Application Nos. DE 10 2008 040 224.9, filed Jul. 7, 2008 and DE 10 2008 048 691.4, filed Sep. 24, 2008; the prior applications are herewith incorporated by reference in their entirety.

### BACKGROUND OF THE INVENTION

### Field of the Invention

The invention relates to a process for conditioning a waste solution which is obtained in the course of wet-chemical cleaning of conventional or nuclear plants and which includes organic substances and metals in ionic form. Such solutions are obtained when, for example, magnetite-containing deposits are removed in the course of the secondary-side cleaning of steam generators of power plants. For that purpose, cleaning solutions which include, for example, at least one organic agent that forms a water-soluble complex with metal ions such as Fe(II) and/or Fe(III), for example an organic acid such as EDTA, are used. Upon completion of the cleaning, waste solutions are present, which include the complexes mentioned and any unconsumed organic agent. In addition, it is also possible for other organic compounds such as amines, and inorganic compounds, for example nitrate and ammonium ions, to be present. A measure employed for the content of organic substances is typically the COD value. It indicates the Chemical Oxygen Demand which is required to degrade the organic substances to CO₂ and water.

Due to a usually high metal content and COD value alone, such waste solutions require environmentally responsible disposal. In the case of solutions without radioactive contamination, some countries, for example Germany, permit disposal by combustion as special waste. When the waste solution has radioactive contamination, which may be the case, for example, in the cleaning of the steam generators of power plants, or combustion is not permitted even in the case of non-radioactive waste solutions, such a procedure is not an option. In a conventional conditioning process, the organic constituents are decomposed electrochemically or electrolytically with the aid of suitable electrodes, ideally completely to carbon dioxide and water. In order to remove the metal ions from the solution, it is passed through ion exchangers. That gives rise to considerable amounts of laden, possibly radioactively contaminated exchange resins as secondary waste, which have to be stored in a temporary or final storage facility in an exceptionally costly manner. In the case of exchange resins laden with metals, the volume ratio between the exchange resin and the volume or the mass of metal ions is exceptionally unfavorable.

### SUMMARY OF THE INVENTION

It is accordingly an object of the invention to provide a method for conditioning a waste solution containing organic substances and metals in ionic form and being obtained during wet-chemical cleaning of conventional or nuclear plants, which overcomes the hereinafore-mentioned disadvantages of the heretofore-known methods of this general type and with which a waste solution of the type specified at the outset can be conditioned in a simple and economically viable manner.

With the foregoing and other objects in view there is provided, in accordance with the invention, a process for conditioning a waste solution which is obtained in the course of wet-chemical cleaning of conventional or nuclear plants and includes at least one organic substance and at least one metal in ionic form, in which at least a portion of the organic substance is degraded by electrochemical treatment of the waste solution, at least one metal is precipitated by addition of phosphoric acid, and the phosphate precipitate formed is removed from the waste solution.

With the objects of the invention in view, there is also provided a process for conditioning a waste solution which is obtained in the course of wet-chemical cleaning of conventional or nuclear plants and includes at least one organic substance and at least one metal in ionic form, in which at least a portion of the organic substance is degraded by irradiation of the waste solution with UV light, at least one metal is precipitated by addition of phosphoric acid, and the phosphate precipitate formed is removed from the waste solution.

In the former process, at least a portion of the organic substances is degraded by electrochemical treatment of the waste solution and the at least one metal is precipitated by addition of phosphoric acid and the phosphate precipitate formed is removed from the waste solution. The latter process differs therefrom in that the metals present in the waste solution are not degraded by an electrochemical treatment, but by a treatment with UV light.

Due to the electrochemical treatment or the irradiation with UV light, organic compounds are ultimately decomposed into CO₂ and water. Metal complexes release these metal ions complexed by them only in the course of decomposition thereof. In both process variants, it is appropriate to work in acidic to weakly basic solution, i.e. in a pH range of about 3 to 9, because this prevents or reduces the formation of metal hydroxide precipitates. Such precipitates form very slowly in the alkaline range sediment and can only be removed, for example filtered off, with very great difficulty. The behavior of phosphate precipitates is quite different. They are not very voluminous and can be removed without any problem, for example by filtration or centrifugation, with a low level of apparatus complexity. In contrast to a removal with an ion exchanger, a significantly smaller volume of waste is obtained in this process.

The phosphoric acid used to precipitate the metal additionally has the advantage that it can serve simultaneously to establish the pH range mentioned (pH of approximately 3 to 9) and, in particular, since it is an oxo acid, it causes an acceleration of the degradation of the organic compounds. An oxo acid or a corresponding acid radical (phosphate) forms, at the anode, peroxo compounds (peroxophosphates) which, as very strong oxidizing agents, accelerate the oxidative decomposition of the organic substances into carbon dioxide and water. The phosphoric acid used in accordance with the invention, which forms sparingly soluble precipitates with many metals such as iron, cobalt or nickel, thus firstly ensures problem-free removal of many metals, especially of iron, from the waste solution and secondly ensures an acceleration of the degradation process.

In the electrochemical decomposition of organic substances in aqueous solution, which is known per se, oxo acids, for example sulfuric acid, were used merely with regard to an acceleration of degradation. A precipitation reaction was not envisaged. Due to the very rapid reaction between the metal ions and the phosphate ions, and the formation of precipitate which takes place rapidly, as explained in detail below, turbidity and other adverse effects are at least reduced.

In the case of the UV variant of the process, a strong oxidizing agent such as hydrogen peroxide is added to accelerate the degradation.

In both process variants, it is conceivable first to perform the degradation of the organic substances present in the waste solution to the desired degree and then to undertake the precipitation of metals by adding phosphoric acid. In the case of both process variants, it is, however, advantageous to commence the precipitation beforehand, and more particularly from the start, i.e. at a time at which the organic constituents are yet to be destroyed completely or to the desired degree. In both process variants, this enhances the effectiveness of the process, as explained in detail below.

The practical performance of the process is possible with a relatively low level of technical complexity. The waste solution to be treated is electrolyzed in a suitable vessel or irradiated with UV light until the organic substances have been degraded to a tolerable residual amount or completely. In the case of an electrolytic treatment, a diamond electrode is used at least as the anode, in order to suppress any troublesome formation of oxygen and to enable the formation of strongly oxidizing peroxo compounds (from oxo compounds, especially from phosphoric acid). When the waste solution being treated is a spent cleaning solution which has been used to clean the steam generator of a power plant, it contains large amounts of iron which originate from magnetite deposits on the steam generator. In order to dissolve this deposit, the cleaning solution contains an organic complexing agent such as EDTA. In order to prevent attack on the metallic material of the steam generator, generally steel, in the course of cleaning, an alkaline medium is employed, which means that the cleaning solution contains an alkalizing agent such as ammonia or ammonium ions or morpholine. In addition, the cleaning solution contains a reducing agent such as hydrazine in order to prevent oxidative attack on the material of the steam generator. After the cleaning, the iron which is present principally in divalent form is dissolved in complex form, for example as the EDTA complex. In addition to iron, it is also possible for other metals such as cobalt or nickel to be present in smaller amounts in such a waste solution. These may also include radionuclides which are passed to the secondary side of the steam generator through small leaks. The cleaning of a steam generator gives rise to large amounts of spent cleaning solution, for instance in the region of a few hundreds of cubic meters, for example 250 m³. In order to be able to treat such amounts of waste solution within an acceptable time, plate electrodes of a porous material are used. The electrode plates have an area, for example, of 28 m² to 40 m². The electrode plates or the outer and also inner surfaces thereof are provided with a thin diamond layer. The duration of the process depends on the particular contamination of the waste solution with organic substances, on the electrode area and on the current density.

In a waste solution of the type mentioned, a pH at which precipitation of a metal hydroxide is prevented or at least reduced is established. This is the case at a pH, for instance, of 3 to 9. In addition to the fact that hydroxide precipitates are difficult to remove from the waste solution, they have the further disadvantage that they settle out on electrode surfaces and UV radiators and impair the function thereof. Working in acidic solution is preferred because the formation of metal hydroxide precipitates which are difficult to filter can be prevented reliably. In addition, phosphoric acid is added to the solution, specifically in an amount which is sufficient to precipitate the metals present in the solution, i.e. principally iron. Preference is given to using stoichiometric amounts of phosphoric acid, since an excess has no effect on the precipitation and would merely increase the secondary waste. For one mole of iron, which corresponds to a mass of 55.85 g, one mole or 98 g of phosphoric acid is required. The phosphoric acid being added already causes acidification of the solution, and so additional measures for adjusting the pH are not usually required. During the electrolysis or UV irradiation, all organic constituents, also including complexing agents, for example EDTA, are decomposed into carbon dioxide and water. In the course thereof, the iron, which is present, for example, with a content in a range of from 5 g/l to 40 g/l, is released, in such a way that it can combine with the phosphate radicals of the phosphoric acid to give sparingly soluble iron phosphate, which collects as a precipitate at the bottom of the vessel. Iron phosphate and also the sparingly soluble phosphates of other metals sediment rapidly and can be removed without any problem from the solution, preferably by filtration or else by centrifugation. This removes virtually the entire metal content including any radionuclides present from the waste solution. The remaining solution then includes at most only residues of incompletely decomposed organic compounds and impurities, and can thus be disposed of in a conventional manner, for example by evaporation or combustion. The phosphates being removed can be sent as special waste for a corresponding disposal measure. In the case of radioactive contamination, they are deposited in an appropriate final or temporary storage facility, optionally after binding into a solid binder matrix.

The addition of phosphoric acid under consideration can in principle be undertaken at any time in the process. However, it has been found that, surprisingly, the process works more effectively when phosphoric acid is present or is added from the start, i.e. during the electrochemical treatment. During the workup of waste solutions, phosphoric acid was added at the start, and in one case toward the end of the process. The waste solutions included comparable amounts of unconsumed EDTA, morpholine, hydrazine and iron. The total content of organic substances corresponded to a chemical oxygen demand or COD value of 320,000 mg O₂/l to 370,000 mg O₂/l . The waste solutions were each treated with diamond plate electrodes of the type described above having a geometric area of approximately 30 m². During the treatment, the iron content and the specific charge supplied in each case were determined at particular time intervals.

Other features which are considered as characteristic for the invention are set forth in the appended claims.

Although the invention is illustrated and described herein as embodied in a method for conditioning a waste solution containing organic substances and metals in ionic form, obtained during wet-chemical cleaning of conventional or nuclear plants, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying embodiments.

### BRIEF DESCRIPTION OF THE SINGLE VIEW OF THE DRAWING

The figure of the drawing is a diagram in which iron content is plotted against specific charge.

### DETAILED DESCRIPTION OF THE INVENTION

Referring now in detail to the single figure of the drawing, there is seen a diagram in which iron content is plotted in mg/l against specific charge in Ah/l. It is evident that, in the cases with an initial addition of the phosphoric acid in a stoichiometric amount with regard to the iron content, at a total amount of charge of 1500 Ah/l, the initial iron content fell from 1100 mg/l or 1300 mg/l to values below 10 mg/l (see the respective curves with triangular and round measurement points in the diagram). When, in contrast, phosphoric acid (likewise with a stoichiometric amount relative to the iron content) was added only toward the end of the process, i.e. at an amount of charge supplied of approximately 1500 Ah/l, it was found that, after the phosphate precipitation, a significantly higher residual content of iron, a content of about 110 mg/l, remained in the waste solution (see the curve with square measurement points in the diagram). When phosphoric acid is present right at the start, free iron is bound immediately and precipitated as iron phosphate. It falls relatively rapidly to the base of the reaction vessel, in such a way that the risk of deposition on the electrode surfaces is very low. In the absence of phosphoric acid, in contrast, iron-containing deposits form on the electrodes, which adversely affect the efficiency of the electrode and of the precipitation.

The decomposition of organic constituents of a waste solution can also, instead of or in addition to an electrochemical treatment, be undertaken by UV irradiation. The UV irradiation in combination with an oxidizing agent such as hydrogen peroxide likewise degrades organic substances, substantially to carbon dioxide and water. This releases complexed metals, in such a way that they can be precipitated and removed in the manner outlined above.

In the case of wastewater treatment with the aid of UV radiation, an initial addition of phosphoric acid is likewise advantageous, especially with regard to the latter effect of coverage of the reaction surface of the UV lamps with iron-containing deposits. It has been observed that, in the case of UV irradiation without the presence of phosphoric acid, or when it has not been added until a later time, that resulted in turbidity of the solution, which leads to a reduction in the UV yield.

1. A process for conditioning a waste solution obtained in the course of wet-chemical cleaning of conventional or nuclear plants and including at least one organic substance and at least one metal in ionic form, the method comprising the following steps:
degrading at least a portion of the organic substance by electrochemical treatment of the waste solution;
precipitating at least one metal by addition of phosphoric acid to form a phosphate precipitate; and
removing the phosphate precipitate from the waste solution.

2. The process according to claim 1, which further comprises carrying out the electrochemical treatment step with an anode having an oxygen overpotential.

3. The process according to claim 1, wherein a further oxo compound is present in the waste solution as well as the phosphoric acid.

4. The process according to claim 1, which further comprises adding to the waste solution an oxidizing agent being effective with respect to the at least one organic substance.

5. The process according to claim 4, which further comprises adding hydrogen peroxide to the waste solution as an oxidizing agent.

6. The process according to claim 1, which further comprises carrying out the step of adding the phosphoric acid at a time when the at least one organic substance is yet to be fully degraded.

7. The process according to claim 6, which further comprises carrying out the step of adding the phosphoric acid at a start of the process.

8. The process according to claim 1, which further comprises carrying out the step of adding the phosphoric acid in a stoichiometric amount with regard to metal content.

9. The process according to claim 1, which further comprises establishing a pH of 3 to 9 in the waste solution.

10. The process according to claim 1, which further comprises treating iron-containing waste solutions with the process.

11. The process according to claim 1, which further comprises conditioning, with the process, a waste solution including an organic complex of a metal.

12. A process for conditioning a waste solution obtained in the course of wet-chemical cleaning of conventional or nuclear plants and including at least one organic substance and at least one metal in ionic form, the method comprising the following steps:
degrading at least a portion of the organic substance by irradiation of the waste solution with UV light;
precipitating at least one metal by addition of phosphoric acid to form a phosphate precipitate; and
removing the phosphate precipitate from the waste solution.

13. The process according to claim 12, which further comprises adding to the waste solution an oxidizing agent being effective with respect to the at least one organic substance.

14. The process according to claim 13, which further comprises adding hydrogen peroxide to the waste solution as an oxidizing agent.

15. The process according to claim 12, which further comprises carrying out the step of adding the phosphoric acid at a time when the at least one organic substance is yet to be fully degraded.

16. The process according to claim 15, which further comprises carrying out the step of adding the phosphoric acid at a start of the process.

17. The process according to claim 12, which further comprises carrying out the step of adding the phosphoric acid in a stoichiometric amount with regard to metal content.

18. The process according to claim 12, which further comprises establishing a pH of 3 to 9 in the waste solution.

19. The process according to claim 12, which further comprises treating iron-containing waste solutions with the process.

20. The process according to claim 12, which further comprises conditioning, with the process, a waste solution including an organic complex of a metal.
